(19) United States
(12) Patent Application Publication
(10) Pub. No.: US 2025/0319493 A1
(43) Pub. Date: Oct. 16, 2025

(54) DETECTION OF RECIRCULATING OBJECTS

(71) Applicant: KÖRBER SUPPLY CHAIN LOGISTICS GMBH, Konstranz (DE)

(72) Inventor: Marco Fischer, Konstanz (DE)

(21) Appl. No.: 18/855,840

(22) PCT Filed: Apr. 17, 2023
(86) PCT No.: PCT/EP2023/059864

§ 371 Date: Oct. 10, 2024

(30) Foreign Application Priority Data
Apr. 22, 2022 (EP) 22169504.2

(51) Int. Cl. B07C 5/36; B07C 3/08

(52) U.S. Cl. CPC B07C 5/362; B07C 3/08

(57) ABSTRACT

A method for operating a logistics system for piece goods includes conveying piece goods in the logistics system along a main conveyor section to an automatic detection system, automatically detecting an error affecting a piece good complex by the detection system, creating a first data record via which the piece good complex can be identified, due to the detected error, ejecting the piece good complex from the main conveyor section to a recirculation conveyor section due to the detected error, which causes the piece good complex to be fed to the detection system again, wherein when the piece good complex is fed in again, the detection system detects the error again and creates a second data record via which the piece good complex can be identified, detecting a match between the first and second data record.

### BACKGROUND

The invention relates to the automation of logistics systems for piece goods with repatriation.

In sorting systems for parcels or suitcases with automated unloading and singulation, the objects to be sorted are transported as 2D/3D bulk goods on conveyor belts to a singulation system (e.g. Visicon, Robot, Variotip). An oriented 1D stream with defined gaps between the objects is then generated.

The objects to be sorted are piece goods, such as parcels, shipping goods or pieces of luggage. Typical applications can be found, for example, in sorting systems at airports or postal or other logistics service providers. The terms “consignment”, “piece good” and “object” are essentially used synonymously in the following.

Inadequacies in the sorting and/or singulation system (for example in mechanical components, in the detection technology or in special feed situations) or certain types of object result in errors. The errors can include, for example, double pull-offs, incorrect orientation of a piece good or an inadequate gap to the next object.

An automatic detection system detects these errors and can recirculate the relevant consignments and feed them back into the singulating system via a recirculation conveyor section (round-course, loop).

There is also the option of removing consignments completely from the flow, i.e. handing them over for manual checking and further processing.

Certain objects are repeatedly recirculated. For example, the cause may be an error detection, wherein a single object is incorrectly detected as a double deduction. Such false detections can also be based on defective objects, open consignments (e.g. open parcels or suitcases), irregularly shaped objects (e.g. L-shaped boxes), special imprints or stickers on the objects, protruding stickers or strips of adhesive tape, glued objects that do not separate even when singulated again.

Even if an address, a barcode or a label cannot be read in an already singulated stream, a similar problem arises. For example, in a baggage sorting system such as those used in airports, a reading station that reads a barcode on a baggage label attached to a piece of baggage can be diverted to a return path in the event of an error in the reading process, which leads the piece of baggage item back to the reading station. However, if the label is damaged and the barcode is illegible, this does not rectify the error, so the baggage item in question circulates until the error is rectified, for example by handling the baggage item manually.

During operation, the rate of these recirculating objects, which are detected by the detection system at periodic intervals depending on the round trip time (RTT), increases. The consequences of this are increased mechanical stress on both the objects and the system, as well as a reduction in the throughput of the system. As a rule, this requires manual intervention, i.e. manual removal of conspicuous objects, manual emptying of the system, or the problem and associated disadvantages must be accepted as long as the sorting system is not too severely impaired and remains functional.

The present invention is based on the object of optimizing the operation of a logistics system for piece goods with recirculation.

### SUMMARY OF THE INVENTION

According to one aspect, the invention relates to a logistics system for piece goods. The logistics system comprises a main conveyor section, a detection system, an ejection system and a recirculation conveyor section. The main conveyor section is designed to feed piece goods to the detection system and to convey them further downstream. The ejection system is designed to feed piece goods, which have been fed to the detection system, from the main conveyor section to the recirculation conveyor section. The recirculation conveyor section is designed to feed piece goods, which have been fed to it by the ejection system, to the detection system again. The detection system is set up to generate a data record for a piece good complex fed to it, by means of which the piece good complex can be identified. A piece good complex can comprise a single piece good or several piece goods. For example, a piece good complex can be or include a piece good cluster that has not been correctly singulated. In another embodiment, a piece good complex is a single singulated piece good. The detection system is also set up to detect an error affecting a piece good complex fed to it and to cause the ejection system to feed the piece good complex affected by the error to the recirculation conveyor section. The detection system is also set up to store at least those data records by means of which piece good complexes fed to the recirculation conveyor section can be identified. Such stored data records can be used to optimize the logistics system. For example, the data records can be used to analyze returned piece goods and thus identify the reason for the return. Based on this, the handling of the piece goods can be changed upstream of the logistics system, for example, in order to avoid recirculation of the piece goods. This can increase the efficiency of the logistics system. Furthermore, the stored data can be used to carry out statistical evaluations in order to provide the earliest possible identification of critical piece goods (e.g. consignments) in the logistics system.

Preferably, the detection system is also set up to compare data records with each other and, if two or more data records match, to classify this match as evidence of a repeatedly faulty piece good complex.

According to one aspect, the invention relates to a method for providing data or for operating a logistics system for piece goods. In the logistics system, piece goods are conveyed along a main conveyor section to an automatic detection system. The detection system automatically detects an error affecting a piece good complex. The detection system automatically creates an initial data record which can be used to identify the piece good complex. Based on the detected error, the piece good complex is diverted from the main conveyor section to a recirculation conveyor section. The recirculation conveyor section causes the piece good complex to be fed to the detection system again. When the piece good complex is fed in again, the detection system detects the error affecting the piece good complex again and creates a second data record by means of which the recirculated piece good complex can be identified. In a further method step, the detection system detects a match between the first and second data records and, based on this, classifies the first and second data records as identifying the same piece good complex and the piece good complex as repeatedly affected by errors.

Advantages and embodiments of the invention, which can be used individually or in combination with one another, are the subject of the subclaims.

According to one embodiment example, the logistics system comprises a singulator. The singulator is designed to singulate piece goods fed to the detection system. The error that causes the detection system to cause the ejection system to feed the defective piece good complex to the recirculation conveyor section is an error in the singulation of the piece good complex. This creates the prerequisites for automatically detecting incorrectly singulated piece goods.

According to an embodiment example, the detection system determines a selection of the following data, which can be stored in the data record:
Time of detection;
Image information of the piece good, a part of the piece good or a piece good cluster;
extracted data of the piece good, a part of the piece good or a piece good cluster, such as one or more heights, one or more volumes, one or more dimensions, one or more colors, one or more types, one or more image fingerprints, one or more surface structures;
one or more barcodes which are attached to the piece good or piece good cluster;
one or more plain texts that are attached to the piece good or piece good cluster and that were extracted using text recognition;
one or more conveyor speeds.

According to an embodiment example, the method step of detecting a match of the first and second data records comprises comparing the second data record with a plurality of stored data records.

According to an embodiment example, the detection system is set up to perform a preferably time-based search space restriction when comparing data records. This enables efficient comparison of data records.

According to an embodiment example, the detection system is also set up to determine a probability for the match of two or more threshold values and, if a threshold value is exceeded by the probability, to classify the match as evidence of a repeatedly faulty piece good complex. This makes it possible for the method step of detecting a match between the first and second data record to include automatically determining a probability for the match and automatically interpreting an exceedance of the threshold value as evidence of a repeatedly faulty piece good complex. In this way, piece good complexes can be classified as repeatedly affected by errors if the error has not been resolved after one or more recirculations, but has changed.

According to an embodiment example, the logistics system is a sorting system. The data contained in a data record is also used for sorting the piece good assigned to the data record. In this way, synergies can be utilized by avoiding the unnecessary redundancy of complex analyses of a piece good, as the data contained in a data record can also be used for sorting the piece good assigned to the data record.

According to an embodiment example, the logistics system comprises a manual processing station. The detection system is set up to cause the ejection system to feed a piece good complex with multiple errors to the manual processing station. This allows the recirculation conveyor section to be automatically relieved by automatically feeding a piece good complex classified as having multiple errors to a manual processing station.

According to one aspect of the invention, an automatic detection method can be used to detect objects. In particular, existing systems can be used here, which makes it particularly easy to implement the system in existing systems.

Furthermore, all or at least some known information from previous decisions can be taken into account. For example, information about mail items (piece goods complexes) that were detected in upstream processes can be taken into account. Furthermore, a database can be kept of the detection results, for example from the last few minutes. This allows the data volumes to be limited, which enables efficient data handling. Furthermore, an algorithm can be provided for the weighted evaluation of different data and classification results. In this way, at least one detected characteristic of a piece good complex can be weighted higher than another. If the higher weighted property is detected again, the piece good complex can be classified differently. This means that piece good complexes that are not expected to produce a better result even if they are recirculated again can be rejected. This allows the system to be operated particularly efficiently. Furthermore, a method can be provided in which subsequent errors from automatic error/double detection are avoided or at least reduced.

According to one aspect of the present invention, a decisive feature of automatic detection systems for reducing manual intervention can therefore be detected. Furthermore, a statistical evaluation and storage can enable the identification of critical shipments/objects. This information can be used, for example, to optimize the packaging process or to retrain the detection system. In addition, material stress that would occur with repeated recirculation can be reduced.

It is also conceivable to use the above embodiments in a system with automatic recirculation (e.g. barcode noread, luggage, letter . . . ) can be used. Increased process stability can be achieved here.

### BRIEF DESCRIPTION OF THE DRAWINGS

Further features, properties and advantages of the present invention are apparent from the following description with reference to the accompanying figures. These show schematically:

FIG. 1 is a block diagram of a logistics system according to an embodiment example of the invention; and

FIG. 2 is a block diagram of a logistics system according to a further embodiment example of the invention.

In the embodiment examples and figures, elements that are identical or have the same effect may be given the same reference symbols. The elements shown and their relative sizes are not to be regarded as true to scale; rather, individual elements may be shown proportionally larger for better visualization and/or better understanding.

### DETAILED DESCRIPTION

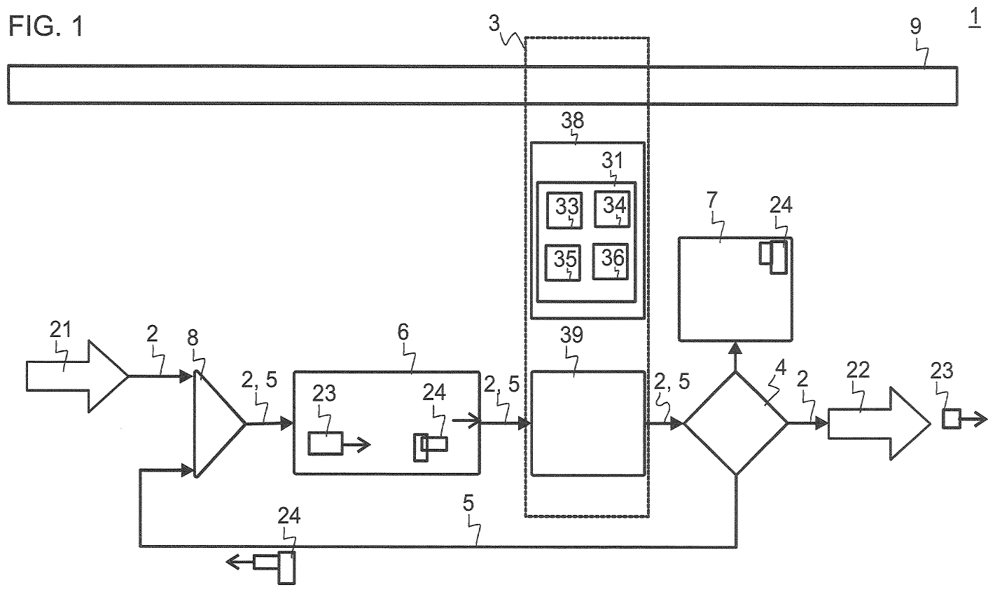

FIG. 1 schematically shows a logistics system 1 for piece goods which comprises an automatic exception detection system 3 with a 3-way split 4 and recirculation 5. The logistics system 1 comprises a main conveyor section 2, a detection system 3, an ejection system 4, a recirculation conveyor section 5, a singulation system 6, a manual processing station 7, a merging system 8 and a control system 9.

The control system 9 is designed and adapted to control the logistics system 1, or at least a selection of the systems 2, 3, 4, 5, 6, 7, 8.

At least the detection system 3 comprises hardware and software or logic. The hardware comprises a camera system 39 or other imaging system with a monitoring area, as well as a control system 38. The software or logic can be implemented in the control system 38 and connected directly to the ejection system 4 in order to control it. Alternatively or additionally, at least part of the software or logic of the detection system 4 may be implemented in the higher-level control system 9 of the logistics system 1. In some embodiments, functionalities of the detection system 3 are therefore implemented in the control system 9, as can be seen by the dashed block 3 which represents the detection system 3 and which overlaps with the control system 9.

The main conveyor section 2 is designed to guide piece goods from a feed system 21 to the merging system 8, from this to the singulation system 6, from this to the detection system 3, from this to the ejection system 4, and from this to possible further processing systems 22.

Upstream of the feeder 2, feeding systems can be arranged which carry out logistical processing steps for the piece goods. For example, the piece goods can be delivered in bulk in an unorganized manner, and the upstream systems generate a single-layer piece goods flow from the stacked piece goods, which is fed to the merging system 8. From the merging system 8, the piece goods are fed to the singulation system 6, where the single-layered piece goods are singulated. In one variant, the piece goods flow with overlapping piece goods is fed to the singulation system 6 and the singulation system 6 generates a single-layer singulated piece goods flow from this.

The detection system 3 comprises a camera system which is designed to generate digital images of piece goods fed to the detection system 3. Ideally, the piece goods are fed to the detection system 3 in a singulated manner. However, if an error occurs in the singulation system 6, it is possible, for example, that a piece good cluster 24 comprising two or more non-singulated piece goods is fed to the detection system 3.

Initially, however, it is not known whether an error has occurred in the singulation or not, but initially piece goods complexes 23, 24 are fed to the detection system 3 by the singulation system 6, which can be a correctly singulated piece good 23 or a faulty piece good cluster 24. In FIG. 1, the reference sign 23 generally designates piece good complexes which comprise only one correctly singulated piece good, whereas the reference sign 24 piece good complexes generally designates piece good clusters which comprise several piece goods.

The detection system 3 is set up to detect from one or more of the digital images by means of digital image processing whether a piece good has been correctly singulated or whether it is part of a piece good cluster. The detection system 3 is thus set up to detect whether a piece good complex 23, 24 is a correctly separated piece good 23 or a faulty piece good cluster 24. The detection system 3 therefore has the object of monitoring the quality of the singulation.

In the embodiment example shown in FIG. 1, the ejection system 4 is designed as a 3-way splitter and is set up to
a) either to convey a piece good complex further along the main conveyor section 2; or
b) to eject a piece good complex from the main conveyor section 2 and feed it to the recirculation conveyor section 5; or
c) to eject a piece good complex from the main conveyor section and feed it to the manual processing station 7.

In one variant, the ejection system can also comprise two 2-way splitters, wherein a first of the 2-way splitters is designed to divert a piece good complex from the main conveyor section to the recirculation conveyor section 5, while a second of the 2-way splitters is designed to feed a piece good complex from the main conveyor section 2 to the manual processing station 7.

If the detection system 3 interprets a piece good complex 23, 24 as correctly singulated piece good 23 and thus as not affected by an error, it controls the ejection system 4 so that the latter conveys the piece good complex 23, or in other words this piece good 23, further along the main conveyor section 2. However, if the detection system 4 detects that a piece goods complex supplied is a piece good cluster 24 comprising two or more non-singulated piece goods, the detection system interprets this piece goods complex 24 as not correctly singulated and thus as affected by an error and controls the ejection system 4 so that it feeds the piece good cluster to the recirculation conveyor section 5.

The detection system 3 is also set up to generate a data record 33, 34, 35, 36 for each feed of a piece good complex 24 to the detection system 4 that is detected as being affected by an error, by means of which the piece good complex can be identified. A data record 33, 34, 35, 36 can, for example, comprises a fingerprint of the piece good complex, which represents geometric, optical and/or physical properties of the piece good complex, for example in the form of a vector. Instead of a vector, the extracted data can also be concatenated to form a number or a string, which then forms a fingerprint, e.g. length_width_height_color. A Deep Learning Process can also be used to determine a value or character string from the image that cannot be directly assigned to humanly understandable values such as “length”.

According to one embodiment example, the detection system is set up to generate a data record only for those piece good complexes that have been detected as affected by errors. According to an alternative embodiment example, the detection system is also set up to generate a data record for other or all piece good complexes fed to the detection system.

The detection system 3 is also set up to store at least those data records 33, 34, 35, 36 in a database 31 by means of which piece good complexes fed to the recirculation conveyor section 5 can be identified. Alternatively, data records can also be generated and stored for all piece good complexes fed to the detection system 3.

The recirculation conveyor section 5 is designed to initially feed a piece good cluster of incorrectly singulated piece goods, which was fed to it by the ejection system 4, back to the singulation system 6 via the merging system 8. In one variant, the logistics system does not comprise a separate merging system 8, but the recirculation conveyor section 5 is designed to feed a piece good cluster of incorrectly singulated piece goods, which were fed to it by the ejection system 4, directly back to the singulation system 6. For example, the recirculation conveyor section 5 can comprise one or more belt conveyors.

If the singulation system 6 correctly singulates the recirculated piece good cluster in this pass, the correctly singulated piece goods are fed to the detection system 6. In this pass, the detection system 6 recognizes these piece good complexes as correctly singulated piece goods and controls the ejection system 4 so that these singulated piece goods are fed further along the main conveyor section to the other processing systems 22.

If the singulation system 6 is also unable to singulate the recirculated piece good cluster 24, for example because the piece goods are stuck together or tangled in one another, the detection system 3 will again detect the piece good complex as a piece good cluster and thus interpret it as affected by an error and create a second data record 34 for this piece good cluster, by means of which the piece good complex 24 can be identified again. The detection system compares this second data record 34 with the data records stored in the database 31. If the second data record 34 matches the first data record stored in the database 31, the detection system 3 classifies the first and second data records 31, 34 as identifying the same piece good complex and the piece good complex as repeatedly affected by errors, or as having already been recirculated at least once, and controls the ejection system 4 to feed this piece good complex to the manual processing station 7. In this way, it is possible to prevent a piece good cluster that the singulation system 6 is unable to singulate from unnecessarily overloading the recirculation conveyor section 5. Instead of a match of two data records, the detection system 3 can also be set up to only eject the piece good cluster in question into the manual processing station 7 when three or more data records match. In this way, the manual processing station can be prevented from being unnecessarily overloaded if two passes through the singulation system are not sufficient to singulate a piece good cluster.

In the embodiment example shown in FIG. 1, the ejection system 4 is arranged downstream of the detection system 3. In other embodiments, the ejection system 4 and the detection system 3 can be arranged in a common section of the main conveyor section 2 or partially overlap. The camera system of the detection system 3 covers a monitoring area that also includes the ejection system 4.

In the embodiment example shown in FIG. 1, the singulation system 6 is arranged upstream of the detection system 3. In other embodiment examples, the singulation system 6 and the detection system 3 can be arranged in a common section of the main conveyor section 2 or can partially overlap. In that the camera system of the detection system 3 covers a monitoring area which also includes the singulation system 6.

In a further embodiment example, the detection system 3 can also cover a monitoring area that covers both the singulation system 6 and the ejection system 4.

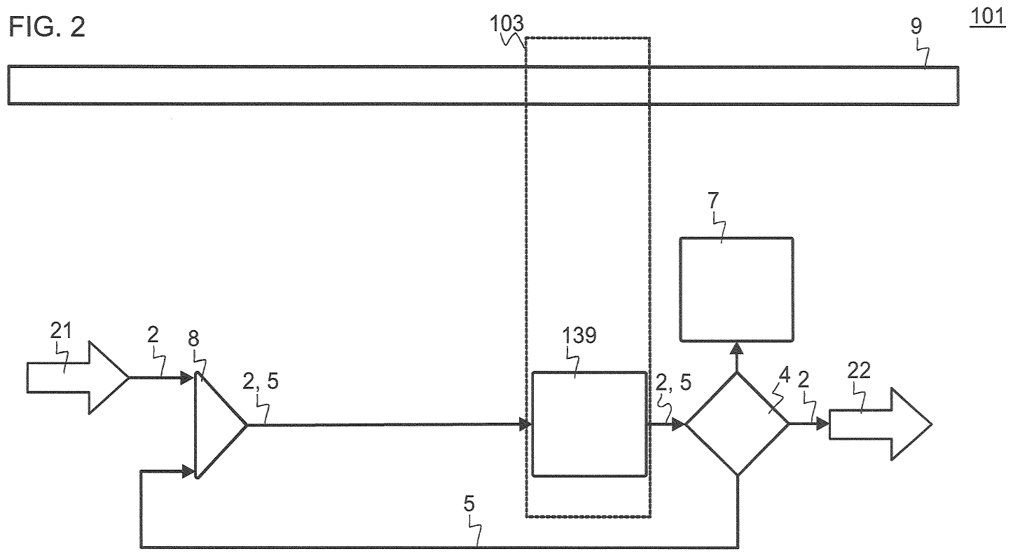

In the embodiment example shown in FIG. 1, the error affecting a piece good complex fed to the detection system 3 is a singulation error. In other embodiment examples, the error that does not affect a piece good complex fed to the detection system 3 is not a singulation error, but another error. Such an embodiment example of a logistics system which can be used in a sorting system like the embodiment example of FIG. 1 is shown schematically in FIG. 2.

FIG. 2 shows a logistics system 101 for piece goods such as parcels or luggage. The sorting system 101 has a similar structure to the logistics system 1, but the logistics system 1 does not include a singulation system and a modified detection system 103. In a baggage sorting system as used in airports, this is generally not necessary, as the items of baggage are already placed individually on the sorting system by an operator or a passenger. Labels representing a sorting destination are attached to or on the piece goods. In the case of parcels, for example, the sorting destination can be an addressee or a sorting or distribution center to which the parcel is to be transported. In the case of luggage, the sorting destination can be, for example, a destination or intermediate destination of a piece of luggage, such as a destination airport. The information required for this can be attached to the label, for example in the form of a barcode, in the form of plain text or can also be stored readable in another information carrier such as an RFID.

If the detection system 103 is unable to extract the information required for sorting, for example because a label is damaged or covered, the piece good in question is detected by the detection system 3 as being affected by an error and the piece good is ejected onto the recirculation conveyor section 5. In this case, the error is therefore a sorting destination that is at least not fully legible.

The detection system 103 is set up to generate a data record for each piece good, by means of which the piece good can be identified.

The detection system 103 is also set up to read out the target destination on the labels and to use it in the further processing systems 22, which may for example comprise a sorter for sorting the piece goods. If a sorting destination for a piece good is fully recognized by the detection system, the detection system 103 causes the ejection system to feed this piece good to the further processing systems 22.

However, if a sorting destination for a piece good is not fully detected by the detection system 103, the detection system 103 causes the ejection system 4 to interpret this piece good as being affected by an error and to feed it to the recirculation conveyor section 5.

The detection system 103 stores a data record for each piece good fed to the recirculation conveyor section 5, by means of which the piece good can be identified.

A faulty piece good that has been ejected into the recirculation conveyor section 5 is thus fed to the detection system 103 again. If the sorting destination is readable this time, for example because the label is no longer covered, the detection system 103 causes the ejection system 4 to feed the piece goods to the further processing systems 22. If the sorting destination is again unreadable, the detection system again creates a second data record for this piece good by means of which the piece good can be identified and compares the second data records with all data records in the database 31 and finds a match with the previously created first data record of this piece good and therefore classifies the piece good as repeatedly affected by errors and causes the ejection system 4 to feed the piece good to the manual processing station 7.

According to further embodiment examples, the detection system 3 is set up to perform a preferably time-based search space restriction when comparing data records. The restriction can, for example, be carried out on the basis of the circulation time of a piece good around the recirculation conveyor section, wherein only data records are compared with each other whose creation, for example, is slightly longer than one or more circulation times ago. The search space restriction can also be clocked on the basis of circulation times so that, for example, only data records that were created in a time interval covering one or more points in time exactly one or more circulation times ago are compared with each other.

The detection system may not be able to detect a piece good complex with 100% certainty, but must calculate an overall probability from various factors by weighting the individual matches (e.g. length 100% identical, width 90% identical, color identical, height 50% identical) that it is a previously seen piece good. Accordingly, a threshold value (e.g. 80% certainty) must be used to decide which action to take.

According to further embodiment examples, the logistics system is a sorting system, and the data contained in a data record is also used to sort the piece goods assigned to the data record. For this purpose, the detection system can be connected to other systems of the sorting system, for example a sorter. The detection system 3, 103 is set up to transmit data or data records to the sorter or the other additional systems of the sorting system, which comprise, for example, a fingerprint or a barcode or other identification by means of which the piece good can be identified or sorted. In this way, synergies can be used for error detection and sorting. For example, time-consuming and unnecessary multiple investigations of fingerprints can be avoided.

According to further embodiment examples, a data record comprises a selection of the following data:
Time of detection;
Image information of the piece good, a part of the piece good or a piece good cluster;
Extracted data of the piece good, part of the piece good or piece good cluster, such as one or more heights, one or more volumes, one or more dimensions, one or more colors, one or more types, one or more image fingerprints, one or more surface textures;
One or more barcodes which are attached to the piece good or piece good cluster;
One or more plain texts attached to the piece good or piece good cluster and extracted using text recognition;
One or more conveyor speeds.

According to further embodiment examples, the detection system is trained to create image fingerprints using Deep Learning methods.

According to an embodiment example, the ejection system is designed to optionally feed piece goods that have been fed to the detection system 3 to a manual processing station 7. In this case, the detection system 3 is set up to cause the ejection system 4 to feed a piece good complex that has been affected by multiple errors to the manual processing station 7.

According to further embodiment examples, a data record comprises an identifier by means of which the piece good complex can be determined on the basis of which the detection system has created the data record.

According to further embodiment examples, the logistics system 1, 101 is designed to track a recirculated piece good complex along the recirculation conveyor section 5. This can be implemented, for example, in such a way that the monitoring area of the detection system 3, 103 covers the entire recirculation conveyor section.

Further embodiment examples include the use of various process-based methods:

According to an embodiment example, the recirculation conveyor section 5 can be emptied regularly. In this case, all detected faulty piece good complexes are automatically conveyed from the recirculation conveyor section 5 to the manual processing station for a circulation period RTT. This reduces the effective detection rate and increases personnel costs. If the supply of new piece good complexes is also stopped, the throughput is reduced instead, with no detrimental effect on the detection rate and with reduced personnel costs.

According to a further embodiment example, the recirculation conveyor section 5 can also be emptied in a triggered manner. The trigger can be activated when the recirculation rate increases, for example when the recirculation rate exceeds a threshold value. However, there may be an increased susceptibility to errors if the error rate of the singulation system 6 fluctuates.

Further embodiment examples include the use of various detection-based methods:

According to further embodiment examples, the data of all recirculated objects is stored, for example:
Time of detection;
Image information of the piece good, a part of the piece good or a piece good cluster;
Extracted data of the piece good, a part of the piece good or a piece good cluster, such as one or more heights, one or more volumes, one or more dimensions, one or more colors, one or more types, one or more image fingerprints, one or more surface structures;
One or more barcodes which are attached to the piece good or piece good cluster;
One or more plain texts attached to the piece good or piece good cluster and extracted using text recognition;
One or more conveyor speeds.

According to further embodiment examples, newly detected exception objects are also compared with a list of previously recirculated piece goods in the relevant time window (e.g. 1 min +/−20 s). By comparing all data, a weighted probability for the occurrence of a recirculation is calculated. The position and orientation on the conveyor section, which is designed as a belt for example, can change slightly during repeated detection, as well as the contour and surface structure of deformable piece good complexes.

According to further embodiment examples, determined data is reused in algorithms of other sorting methods such as ArtID/Letter Fingerprint, modified if necessary. If necessary, a 3-strike rule or an n-strike rule can also be applied, i.e. piece good complexes must undergo at least two or more recirculations in order to be flagged as repeatedly faulty or repeatedly recirculated.

Decisions for statistical evaluation can be logged.

Further embodiment examples include:
Application of automatic detection methods for the recognition of objects;
Inclusion of all known information from previous decisions;
Keeping a database of the detection results of the last few minutes;
Algorithms for the weighted evaluation of different data and classification results;
Methods for reducing subsequent errors of an automatic error, in particular double detection.

According to embodiment examples, the following advantages can result:
Reduction of manual interventions;
Statistical evaluation and storage enables identification of critical consignments/objects which can be used, for example, for process optimization in packaging or for post-training of detection;
Reduction of material stress that would occur with repeated recirculation; for example, consignments or other piece goods that would often be conveyed in a circle on the recirculation conveyor section without automatic classification as affected by multiple errors and would therefore be subject to high mechanical stress are protected.

Increasing throughput or maintaining throughput;
Methodology can also be applied to other systems with automatic recirculation (e.g. barcode noread, baggage, letter . . . );
Increased process stability.

1.-18. (canceled)

19. A logistics system for piece goods, comprising:
a main conveyor section;
a detection system;
an ejection system; and
a recirculation conveyor section;
wherein the main conveyor section is configured to convey piece goods to and from the detection system further downstream;
wherein the ejection system is configured to feed piece goods, which have been fed to the detection system, from the main conveyor section to the recirculation conveyor section;
wherein the recirculation conveyor section is configured to feed piece goods, which have been fed to it by the ejection system, to the detection system again;
wherein the detection system is configured to generate a data record for a piece good complex fed to the detection system, via which the piece good complex can be identified;
wherein the detection system is configured to detect an error affecting the piece good complex fed to the detection system and to cause the ejection system to feed the piece good complex affected by the error to the recirculation conveyor section; and
wherein the detection system is configured to store the data records via which piece good complexes fed to the recirculation conveyor section can be identified.

20. The logistics system according to claim 19, wherein the detection system is configured to compare data records with one another and, in the event of a match between two or more of the data records, to classify the match as evidence of a repeatedly faulty piece good complex.

21. The logistics system according to claim 19, further comprising:
a singulator configured to singulate piece goods fed to the detection system and the error, on the basis of which the detection system causes the ejection system to feed the piece good complex affected by the error to the recirculation conveyor section, is an error in the singulation of the piece good complex.

22. The logistics system according to claim 19, wherein a data record comprises a selection of the following data:
time of detection;
image information of the piece goods, a part of the piece good or a piece good cluster, wherein the image information can also include several images from different perspectives;
extracted data of the piece good, a part of the piece good or a piece good cluster, including at least of one or more heights, one or more volumes, one or more dimensions, one or more colors, one or more types, weight, recognizable sub-elements, position in relation to other piece goods, one or more image fingerprints, and one or more surface structures;
one or more barcodes which are attached to the piece good or piece good cluster;
one or more plain texts that are attached to the piece good or piece good cluster and that were extracted using text recognition; and
one or more conveyor speeds.

23. The logistics system according to claim 19, wherein the detection system is configured to perform a time-based search space restriction when comparing data records.

24. The logistics system according to claim 19, wherein the detection system is configured to determine a probability for the match of two or more threshold values and, if a threshold value is exceeded by the probability, to classify the match as evidence of a repeatedly faulty piece good complex.

25. The logistics system according to claim 19, wherein the logistics system includes a sorting system and the data contained in a data record is additionally used for sorting the piece good assigned to the data record.

26. The logistics system according to claim 19, further comprising:
a manual processing station, wherein the detection system is configured to cause the ejection system to feed a piece good complex affected by multiple errors to the manual processing station.

27. The logistics system according to claim 19, wherein the detection system is configured to calculate a weighted probability for the occurrence of a recirculation by comparing all data.

28. A method for operating a logistics system for piece goods, comprising:
conveying piece goods in the logistics system along a main conveyor section to an automatic detection system via the detection system;
automatically detecting an error affecting a piece good complex;
creating a first data record, via which the piece good complex can be identified;
ejecting the piece good complex from the main conveyor section to a recirculation conveyor section due to the detected error, which causes the piece good complex to be fed to the detection system again, wherein when the piece good complex is fed again, the detection system detects the error again and creates a second data record via which the piece good complex can be identified; and
detecting a match of the first and second data records.

29. The method according to claim 28, further comprising:
classifying the piece good complex as repeatedly affected by errors based on matching the first and second data records.

30. The method according to claim 28, wherein the piece goods fed to the detection system are conveyed through a singulator and the detection system measures the quality of the singulation of the piece good complex.

31. The method according to claim 28, wherein a data record comprises a selection of the following data:
time of detection;
image information of the piece good, a part of the piece good or a piece good cluster;
extracted data of the piece good, a part of the piece good or a piece good cluster, including at least one of one or more heights, one or more volumes, one or more dimensions, one or more colors, one or more types, one or more image fingerprints, and one or more surface structures;
one or more barcodes which are attached to the piece good or piece good cluster;
one or more plain texts that are attached to the piece good or piece good cluster
and that were extracted using text recognition; and
one or more conveyor speeds.

32. The method according to claim 28, wherein detecting the match of the first and second data records comprises comparing the second data record with a plurality of stored data records.

33. The method according to claim 32, wherein the detection system is arranged to perform a time-based search space restriction when comparing data records in order to select the plurality of data records with which the second data record is compared.

34. The method according to claim 28, wherein detecting the match of the first and the second data record comprises automatically determining a probability for the match and automatically interpreting an exceeding of the threshold value as evidence for a repeatedly faulty piece good complex.

35. The method according to claim 28, wherein the data contained in a data record is additionally used for sorting the piece goods assigned to the data record.

36. The method according to claim 28, wherein the piece good complex classified as being affected by multiple errors is automatically fed to a manual processing station.
